(19) United States
(12) Patent Application Publication
(10) Pub. No.: US 2014/0313992 A1
(43) Pub. Date: Oct. 23, 2014

(54) SYSTEM AND INFORMATION PROCESSING APPARATUS

(71) Applicant: BUFFALO INC., Nogaoya-shi (JP)

(72) Inventor: Satoru Yamaguchi, Nagoya-shi (JP)

(73) Assignee: BUFFALO INC., Nagoya-shi (JP)

(21) Appl. No.: 14/200,748

(22) Filed: Mar. 7, 2014

(30) Foreign Application Priority Data
Apr. 18, 2013 (JP) 2013-87311

(51) Int. Cl. H04W 72/02

(52) U.S. Cl. CPC H04W 72/02
USPC 370/329

(57) ABSTRACT

An information processing apparatus that selects a channel recommended to be used upon receiving a notification of a detection result indicating that a first wireless communication device among a plurality of wireless communication devices has detected a specific radio wave; and transmits channel information indicating the recommended channel a second wireless communication device among the plurality of wireless communication devices located near the first wireless communication device.

### CROSS-REFERENCE TO RELATED APPLICATIONS

The present application claims priority from Japanese Patent Application No. 2013-087311 filed on Apr. 18, 2013, the entirety of disclosure of which is hereby incorporated by reference into this application.

### TECHNICAL FIELD

The disclosure relates to a communication system including a plurality of wireless communication devices and a server.

### BACKGROUND ART

JP 2007-214713A describes a technique, wherein when receiving a notice of detection of radar wave from any access point under management of a policy server, the policy server takes into account the position information of each access point under its management and determines a channel after change on consideration of the channel arrangement of an entire wireless LAN network.

The problem of the above prior art is that this technique is limited to only the abstractive concept of “taking into account the position information of an access point” and does not specifically use the position information of a wireless communication device like an access point. Other needs include, for example, downsizing of a device, cost reduction, resource saving, easiness of manufacture and improved usability.

### SUMMARY

According to one aspect of the disclosure, there is provided an information processing apparatus that selects a channel recommended to be used upon receiving a notification of a detection result indicating that a first wireless communication device among a plurality of wireless communication devices has detected a specific radio wave; and transmits channel information indicating the recommended channel a second wireless communication device among the plurality of wireless communication devices located near the first wireless communication device.

### BRIEF DESCRIPTION OF DRAWINGS

FIG. 1 is a diagram illustrating the general configuration of a communication system;

FIG. 2 is a block diagram illustrating the internal configuration of a server;

FIG. 3 is a block diagram illustrating the internal configuration of a wireless communication device;

FIG. 4 is a flowchart showing a channel control process;

FIG. 5 is a flowchart showing a change trigger detection process;

FIG. 6 is a table showing various notices stored in the server;

FIG. 7 is a flowchart showing a channel mapping process;

FIG. 8 is a flowchart showing a channel change process;

FIG. 9 is a block diagram illustrating the internal configuration of a server (second embodiment);

FIG. 10 is a block diagram illustrating the internal configuration of a wireless communication device (second embodiment);

FIG. 11 is a flowchart showing a channel control process (second embodiment); and

FIG. 12 is a flowchart showing a channel mapping process (second embodiment).

### DESCRIPTION OF EMBODIMENTS

### A. First Embodiment

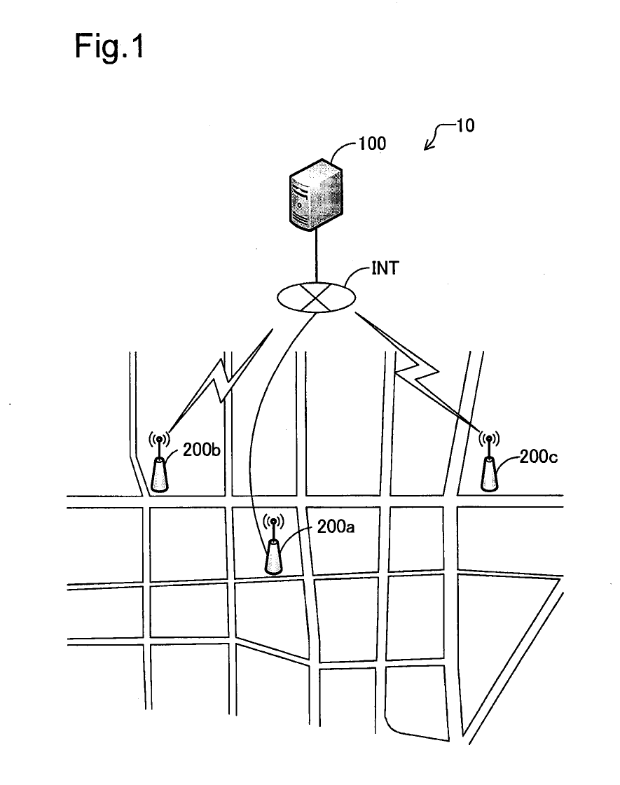

FIG. 1 illustrates the general configuration of a communication system 10. The communication system 10 includes a server 100 and a plurality of wireless communication devices. Wireless communication devices 200a, 200b and 200c are illustrated as the plurality of wireless communication devices in FIG. 1. A larger number of wireless communication devices may, however, be included in the communication system 10. Each of the wireless communication devices 200a, 200b and 200c in combination with any arbitrary number of client devices (not shown) forms a wireless LAN (Wireless Local Area Network). In the description below, the wireless communication device 200a, the wireless communication device 200b and the wireless communication device 200c are called “wireless communication device 200” unless individual discrimination is required. A wireless communication device capable of making inter-access point communication using the WDS (Wireless Distribution System) function may be added to the communication system 10. The server 100 and the wireless communication device 200 establish communication with each other via the Internet INT.

The first wireless communication device 200a is a wireless LAN access point in conformity with the IEEE 802.11 standard. This wireless communication device 200a may be connected to the Internet INT via a cable and may be configured to serve as a third layer router in the OSI reference model. The wireless communication devices 200b and 200c are portable routers in conformity with the IEEE 802.11 standard and are respectively connected to the Internet INT via base stations of a mobile communication network.

Each of the client devices making wireless communication with the wireless communication device 200 is a personal computer or a smartphone having a wireless communication interface in conformity with the IEEE 802.11 standard.

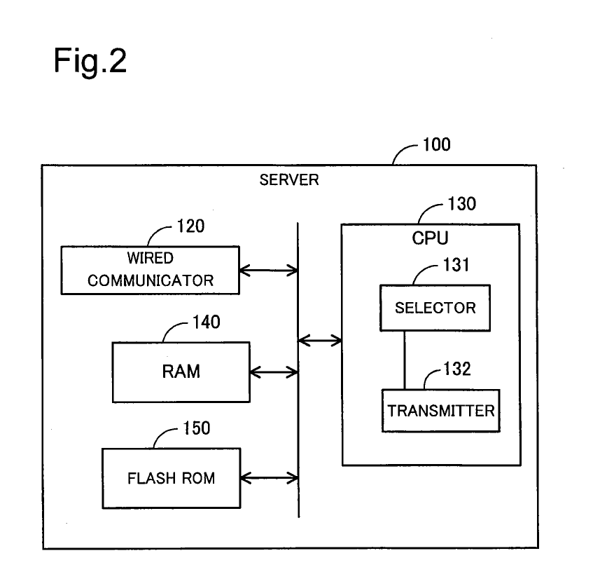

FIG. 2 is a block diagram illustrating the internal configuration of the server 100. The server 100 includes a wired communicator 120, a CPU 130, a RAM 140 and a flash ROM 150. These are interconnected via a bus.

The wired communicator 120 performs a process of shaping the waveform of a signal received via the Internet INT and a process of extracting a MAC frame from the received signal. The CPU 130 loads and executes a computer program for a channel mapping process (described later) on the RAM 140 to serve as a selector 131 and a transmitter 132. The computer program for the channel mapping process is stored in the flash ROM 150.

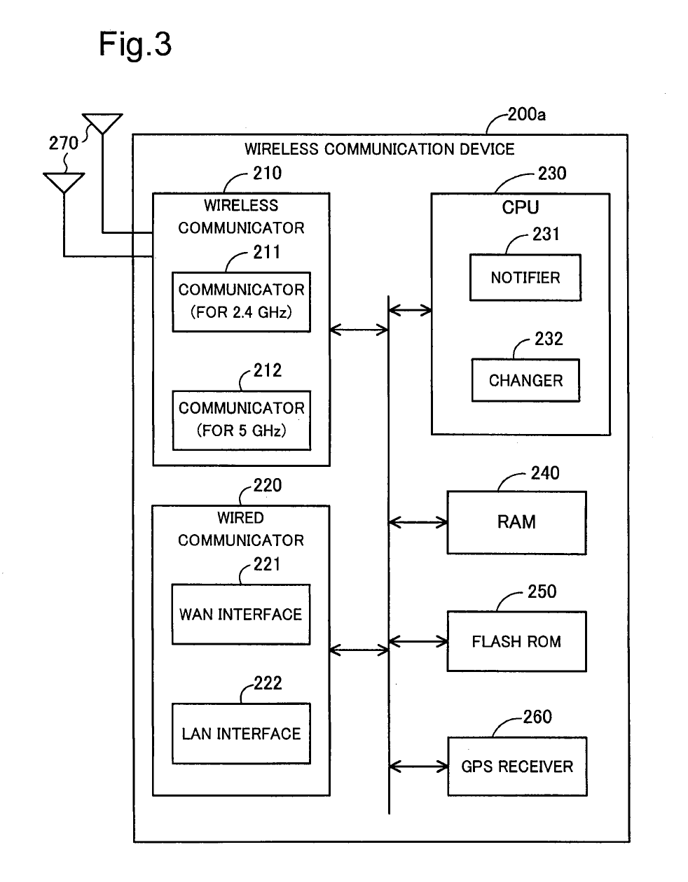

FIG. 3 is a block diagram illustrating the internal configuration of the wireless communication device 200a. The wireless communication device 200a includes a wireless communicator 210, a wired communicator 220, a CPU 230, a RAM 240, a flash ROM 250 and a GPS receiver 260. These are interconnected via a bus.

The wireless communicator 210 includes a communicator 211 for 2.4 GHz, a communicator 212 for 5 GHz and two antennas 270. The wireless communicator 210 performs demodulation of radio wave received via the antenna 270 and generation of data, as well as generation and modulation of radio wave to be sent via the antenna 270. The wireless communicator 210 employs MIMO (Multiple Input Multiple Output).

The communicator 211 makes communication using channels belonging to a 2.4 GHz band in conformity with the wireless LAN standard. The communicator 212 makes communication using channels belonging to a 5 GHz band in conformity with the wireless LAN standard. The communicator 212 has the function of detecting radar wave. According to the rules and regulations in Japan at the time of filing, the frequency bands as the detection target of radar wave are frequency bands of “all channels (52ch to 64ch) in 5.25 to 5.35 GHz (hereinafter referred to as “W53”)” and “all channels (100ch to 112ch) in 5.470 to 5.570 GHz (hereinafter referred to as “W56”)”. The frequency bands as the detection target of radar wave are, however, not limited to the foregoing but may be determined according to the rules and regulations of any foreign country, such as USA and China.

The wired communicator 220 performs a process of shaping the waveform of a received signal and a process of extracting a MAC frame from the received signal. The wired communicator 220 includes a WAN interface 221 and a LAN interface 222. The WAN interface 221 is connected with a line on the Internet INT side. The LAN interface 222 is connected with a client device as the object of wired connection.

The CPU 230 loads and executes a computer program for a channel control process (described later) on the RAM 240 to serve as a notifier 231 and a changer 232. The computer program for the channel control process is stored in the flash ROM 250.

The GPS receiver 260 includes a GPS antenna and an RF module and provides the CPU 230 with latitude and longitude information indicating a current position.

The wireless communication devices 200b and 200c have similar internal configurations to that of the wireless communication device 200a, except omission of the wired communicator 220.

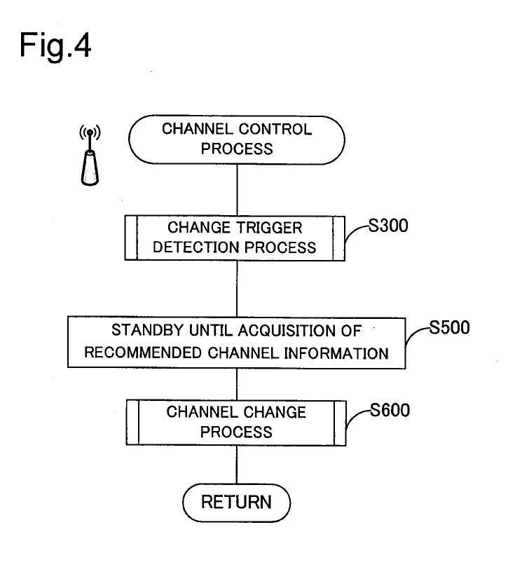

FIG. 4 is a flowchart showing a channel control process performed by the wireless communication device 200. The channel control process is performed continuously by the CPU 230 of the wireless communication device 200. The CPU 230 repeats a change trigger detection process (step S300), standby until acquisition of recommended channel information (described later) from the server 100 (step S500) and a channel change process (step S600) as the processing flow of channel control process.

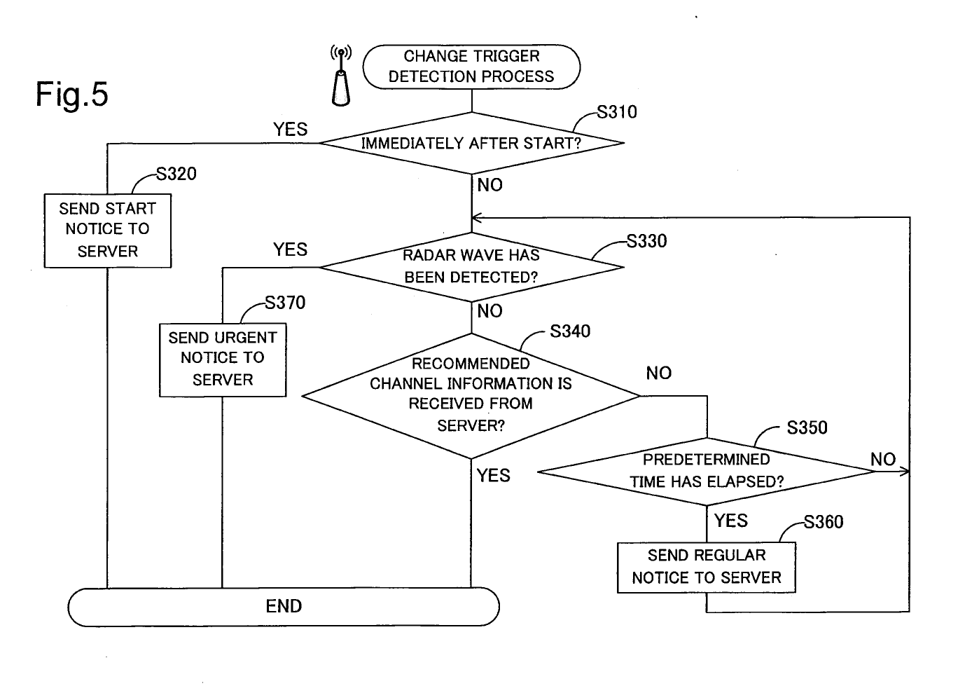

FIG. 5 is a flowchart showing the change trigger detection process performed by the wireless communication device 200. This change trigger detection process is performed by the notifier 231 of the wireless communication device 200. The CPU 230 first determines whether it is immediately after a start of the wireless communication device 200 (step S310). In other words, it is determined whether it is immediately after a start of the channel control process (FIG. 4). When it is immediately after a start (step S310: YES), the CPU 230 establishes TCP connection (Transmission Control Protocol connection) with the server 100 and sends a start notice to the server 100 (step S320), before terminating the change trigger detection process.

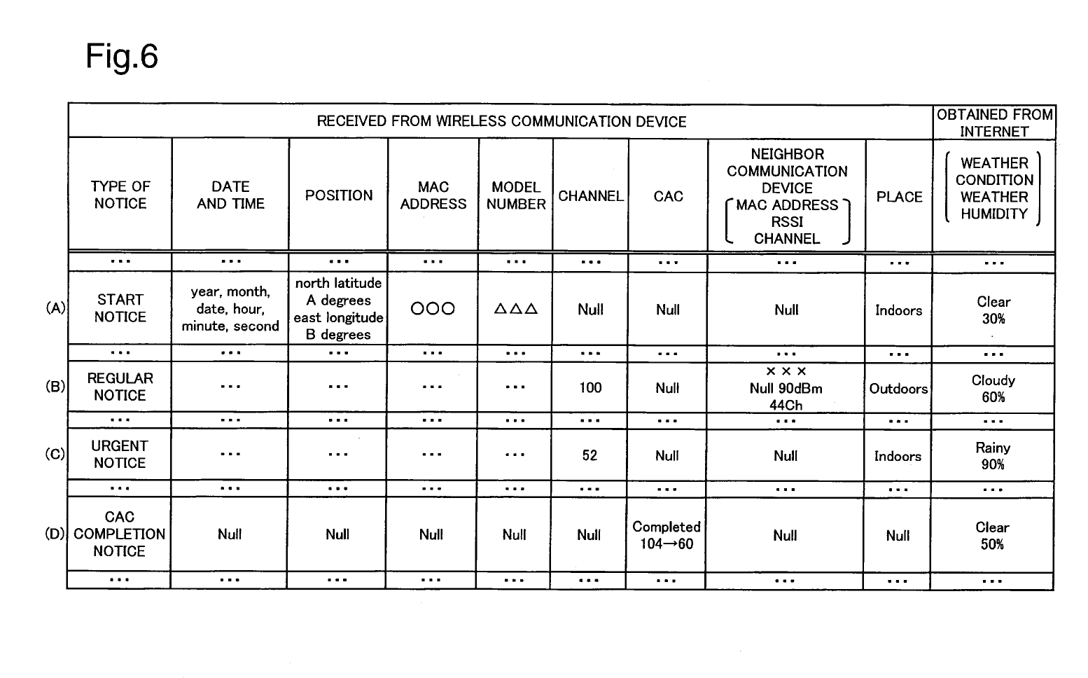

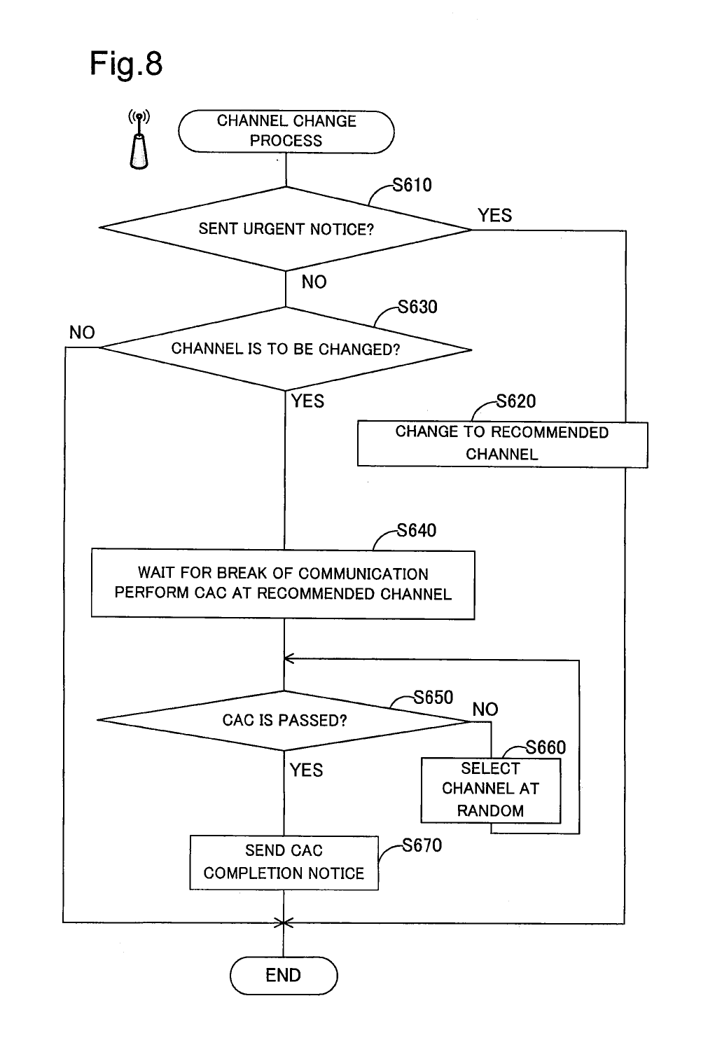

FIG. 6 is a table showing information records sent from the wireless communication device 200 to the server 100 and stored in the server 100. Each of these information records is additionally stored in the flash ROM 150 included in the server 100 every time some notice is sent from the wireless communication device 200 to the server 100. The types of notices sent from the wireless communication device 200 to the server 100 include the start notice at step S320, a regular notice (described later) at step S360, an urgent notice (described later) at step S370 and a CAC (Channel Availability Check) completion notice (described later) at step S670 (described later with reference to FIG. 8) as shown in FIG. 6. Information records registered by only part of notices are shown in FIG. 6 for the purpose of illustration, and the server 100 actually receives a large number of notices from a plurality of the wireless communication devices 200 and stores received information records.

As shown by a record (A) in FIG. 6, information included in the start notice includes type of a notice, date and time, position, MAC address, model number and place. The information on the date and time indicates the date and time when the notice is sent. The information on the position indicates the latitude and the longitude of the current position of the wireless communication device 200. The information on the MAC address and the model number is information regarding the wireless communication device 200 itself as the sender. The information on the place indicates whether the wireless communication device 200 as the sender is located indoors or outdoors. The CPU 230 of the wireless communication device 200 identifies its own position, based on information input from the GPS receiver 260. For example, when the GPS receiver 260 receives radio wave of an indoor GPS, the CPU 230 may identify the own position as indoor. In another example, when the GPS receiver 260 receives radio wave from a GPS satellite, the CPU 230 may identify the own position as outdoor based on the radio field intensity of higher than a predetermined reference value and identify as indoor based on the lower radio field intensity.

As shown in FIG. 6, information on weather conditions is correlated to each of the records of all the notices including the start notices. The information on the weather conditions indicates the current weather conditions at the current position of the wireless communication device 200. The server 100 obtains the information on the weather conditions via the Internet INT. The information on the weather conditions may include information on the weather (e.g., clear, cloudy, rainy) and the humidity. The information included in the start notice and the information on the weather conditions are used for selection of a channel (described later in detail).

When it is not immediately after a start (step S310: NO), on the other hand, the CPU 230 determines whether radar wave has been detected at the current working channel (step S330). When no radar wave has been detected (step S330: NO), the CPU 230 subsequently determines whether recommended channel information is received from the server 100 (step S340). When no recommended channel information is received (step S340: NO), the CPU 230 determines whether a predetermined time (for example, 1 minute) has elapsed since a previous cycle of step S350 (step S350). When the predetermined time has not yet elapsed since the previous cycle of step S350 (step S350: NO), the CPU 230 returns to step S330. When the predetermined time has elapsed (step S350: YES), the CPU 230 sends a regular notice to the server 100 (step S360) and returns to step S330.

A record (B) in FIG. 6 shows information sent by the regular notice. The regular notice includes information on a channel and a neighbor wireless communication device (hereinafter referred to as “neighbor communication device”), in addition to the information sent by the start notice. The information on the channel indicates a channel number used for wireless communication by the wireless communication device 200 that sends the regular notice (hereinafter referred to as “regular notification device”). The information on the neighbor communication device includes information on the MAC address of the neighbor communication device, RSSI (Received Signal Strength Indication) and a channel used by the neighbor communication device. The wireless communication device 200 obtains these pieces of information by carrier sense or ad hoc communication. When failing to obtain any information on the neighbor communication device, the wireless communication device 200 does not send the information on the neighbor communication device.

When radar wave has been detected at the current working channel (step S330: YES), on the other hand, the notifier 231 of the CPU 230 sends an urgent notice to the server 100 (step S370) and terminates the change trigger detection process.

A record (C) in FIG. 6 shows information sent by the urgent notice. The information sent by the urgent notice includes information on a channel, in addition to the information sent by the start notice. More specifically, the information sent by the urgent notice is the same as the information sent by the regular notice, except omission of the information on the neighbor communication device. The information on the neighbor communication device is not sent, with a view to completing transmission as soon as possible.

When receiving the recommended channel information from the server 100 (step S340: YES) while repeatedly sending the regular notice (step S350) without detecting radar wave (step S330: NO), the CPU 230 terminates the change trigger detection process.

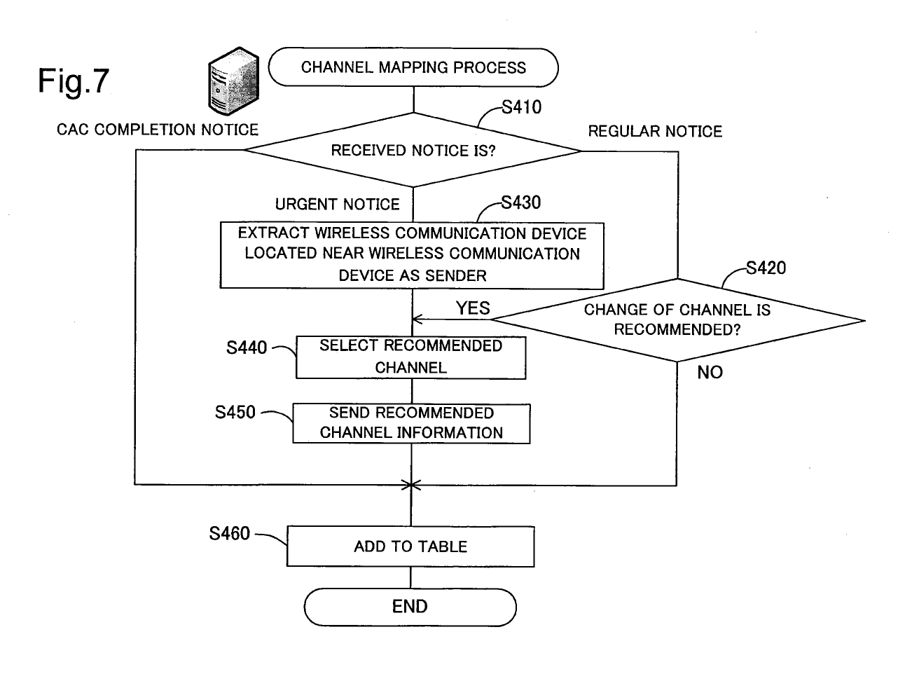

FIG. 7 is a flowchart showing a channel mapping process. This process is triggered by the server 100 receiving some notice from the wireless communication device 200 and is started by the CPU 130 of the server 100.

When the received notice is a regular notice (step S410), the CPU 130 determines whether a change of the channel is recommended to the regular notification device (step S420). This determination is based on the result of learning of notices sent from the regular notification device in the past and notices sent from a plurality of other wireless communication devices 200 in the past. For example, a change of the channel is recommended when both of the following two conditions are satisfied:

### <Condition 1>

At least any one of entries among a plurality of entries (the date and time, the position of the wireless communication device, the model number of the wireless communication device, the channel, the place (identification between indoors/outdoors) and the weather conditions) in historical information records accumulated in the past has a significant correlation to the detection probability of radar wave; and

### <Condition 2>

A significantly high detection probability of radar wave by the regular notification device is estimated from the above correlation and the contents of the regular notice.

The determination of the correlation in Condition 1 and the estimation in Condition 2 may be implemented by a statistical technique using, for example, multivariate analysis or factor analysis. The criterion for determining the significance of the correlation and the criterion for determining the significance of the estimation may be set arbitrarily. The “model number of the wireless communication device” is used to determine a correlation of the model specified by the model number to the detection probability of radar wave. The model number of the wireless communication device is added, because of the possibility that the detection accuracy of radar wave may differ by the model of the wireless communication device. The weather conditions are added, in order to consider the effect of radio wave attenuation by rainfall. The radio wave attenuation by rainfall may affect the radio wave even in the 5 GHz band. Radar wave may, however, reach the further distance by taking into account the reflection from clouds, so that radio wave is not always attenuated in the rain.

When a change of the channel is recommended (step S420: YES), the selector 131 selects a recommended channel (step S440). The channel selected as the recommended channel is a channel in the 5 GHz band, for which CAC is regarded as unnecessary. The channels for which CAC is regarded as unnecessary are channels belonging to W52 (four channels in the 5.2 GHz band) and channels belonging to W53 or W56 which are continuously used for a latest predetermined time (for example, 1 minute) by the wireless communication device 200 located near the regular notification device (hereinafter referred to as “nearby communication device”). When the regular notification device is located outdoors, however, W52 and W53 are excluded. The above term “located near” is preferably defined to enable estimation that the receiving conditions are almost equivalent in terms of detection of radar wave. For example, the “nearby communication device” may be defined as a wireless communication device that satisfies one or both of the following conditions (A) and (B):

(A) another wireless communication device located at the nearby latitude and longitude (device located within a predetermined distance) to those of the wireless communication device 200 of interest (regular notification device in the above description); and

(B) another wireless communication device having a difference within a predetermined range from the parameter of the wireless communication device 200 of interest, with respect to a specified radar wave detection parameter such as radar wave detection accuracy.

Accordingly, the neighbor communication device is not necessarily identical with the nearby communication device.

When there are a plurality of channels satisfying the conditions as the recommended channel, the CPU 130 selects a channel having a statistically low detection probability of radar wave among these channels by the similar technique to that described regarding step S420. When there are a plurality of channels having the low detection probability of radar wave, the CPU 130 selects a channel having a low degree of congestion. The CPU 130 may determine the degree of congestion of a channel, based on the working conditions of the channel by the neighbor communication device. The recommended channel may not be a single channel but may be a plurality of channels. The plurality of channels may be a combination that is subjected to channel bonding or may be a combination that is not subjected to channel bonding. When no adequate channel for use is currently found in the 5 GHz band by taking into account these conditions, the CPU 130 selects a channel in the 2.4 GHz band.

The transmitter 132 subsequently sends recommended channel information regarding the recommended channel to the regular notification device (step S450). The CPU 130 then adds the received regular notice to the table stored in the server 100 (step S460) and terminates the channel mapping process. When a change of the channel is not recommended (step S420: NO), the CPU 130 performs the operation of step S460.

When the received notice is an urgent notice (step S410), on the other hand, the CPU 130 extracts one or plural wireless communication devices corresponding to the nearby communication device located near the wireless communication device which sends the urgent notice (hereinafter referred to as “detection communication device”) from the table, among other wireless communication devices which use at least part of the channels used by the detection communication device (step S430).

Subsequently, the selector 131 performs selection of the recommended channel as described above (step S440); the transmitter 132 performs transmission of the recommended channel information (step S450); and the CPU 130 performs addition of an information record to the table (step S460). When receiving the urgent notice, however, the CPU 130 performs selection of the recommended channel (step S440) and transmission of the recommended channel information with respect to not only the detection communication device but each of the one or plural nearby communication devices extracted at step S430.

When the received notice is a CAC completion notice (described later with reference to FIG. 8) (step S410), on the other hand, the CPU 130 performs the operation of step S460 and terminates the channel mapping process.

FIG. 8 is a flowchart showing a channel change process performed by the wireless communication device 200. This process is triggered by the wireless communication device 200 receiving the recommended channel information and is performed by the CPU 230 after step S500 (FIG. 4) described above. The CPU 230, however, skips step S500 when the change trigger detection process is terminated upon decision of YES at step S340 (FIG. 5).

When the wireless communication device 200 has sent an urgent notice (step S610: YES), i.e., when the received recommended channel information regards an urgent notice, the changer 232 changes the channel according to the received recommended channel information step S620) and terminates the channel change process. When performing operation of step S620, the CPU 230 does not perform CAC but starts wireless communication using a channel after change. When a plurality of channels are included in the recommended channel information, the CPU 230 selects a channel to allow for channel bonding and thereby maximize the band width. When there are a plurality of selection options maximizing the band width, the CPU 230 selects, for example, a channel having the minimum RSSI.

When the wireless communication device 200 has not sent an urgent notice (step S610: NO), on the other hand, i.e., when the received recommended channel information regards either a start notice or a regular notice or regards an urgent notice sent by the nearby communication device, the CPU 230 determines whether the channel is to be changed (step S630). This determination is, for example, based on the results of past learning (learning whether radar wave was detected within a predetermined time after a change of the channel, as the result of changing the channel according to the recommended channel information in the past).

When the channel is to be changed (step S630: YES), the CPU 230 waits for break of communication and performs CAC for a predetermined time (for example, 1 minute) at a channel after change (step S640). Break of communication indicates the state that communication is interrupted for a predetermined or longer time period. On the contrary, “continuing communication” is, for example, downloading an application program. Waiting for break of communication is attributed to the following reason: the wireless communication device 200 with no detection of radar wave has little need to change the channel even by interrupting the continuing communication, such as downloading, since it is not necessary to release from the current working channel immediately (more specifically, within 10 seconds).

When CAC is not passed (step S650: NO), i.e., when radar wave is detected at the channel after change, the CPU 230 selects a channel at random (step S660) and performs the operation of step S650 again.

When CAC is passed (step S650: YES), the CPU 230 sends a CAC completion notice by wireless communication using the channel after change (step S670) and terminates the channel change process. The CAC completion notice is used to send CAC information as shown by a record (D) of FIG. 6. The CAC information includes a channel before change and a channel after change and indicates that CAC is passed.

When the channel is not to be changed (step S630: NO), on the other hand, the CPU 230 terminates the channel change process.

The embodiment described above has at least the following advantageous effects:

(a) The wireless communication device 200 changes the channel without CAC when detecting radar wave. This shortens the interruption time of communication;

(b) The wireless communication device 200 receives a notice of radar wave detection by the nearby communication device. When the wireless communication device 200 uses the same channel as that used by the nearby communication device, it is highly probable that the channel can be changed prior to detection of radar wave; and

(c) The wireless communication device 200 obtains the recommended channel information determined by learning (statistical operation) by the server 100. This learning fits the reality by taking into account another information obtained outside of the wireless communication device 200, more specifically information regarding the weather conditions, in addition to the information obtained from the plurality of wireless communication devices 200. Another information obtained outside of the wireless communication device 200 may be a different type of information other than the information regarding the weather conditions.

### B. Second Embodiment

A wireless communication device 300 according to a second embodiment makes wireless communication using a standard which needs verification that no specific radio wave (for example, radar wave) has been detected at a selected channel for a predetermined time before starting wireless communication using one or more channels selected among a plurality of channels. When detecting specific radio wave, a notifier 231 of the wireless communication device 300 notifies a server 100B of a detection result. When receiving a notice of the detection result of specific radio wave from the wireless communication device 300, a selector 131 of the server 100B selects a channel after change, based on the notice of the detection result of specific radio wave. A transmitter 132 of the server 100B then sends channel information indicating the channel selected by the selector 131 to another wireless communication device 300 located near the wireless communication device 300 which is the sender of the notice. When receiving this channel information, a changer 232 of the wireless communication device 300 changes the channel used for communication based on the received channel information.

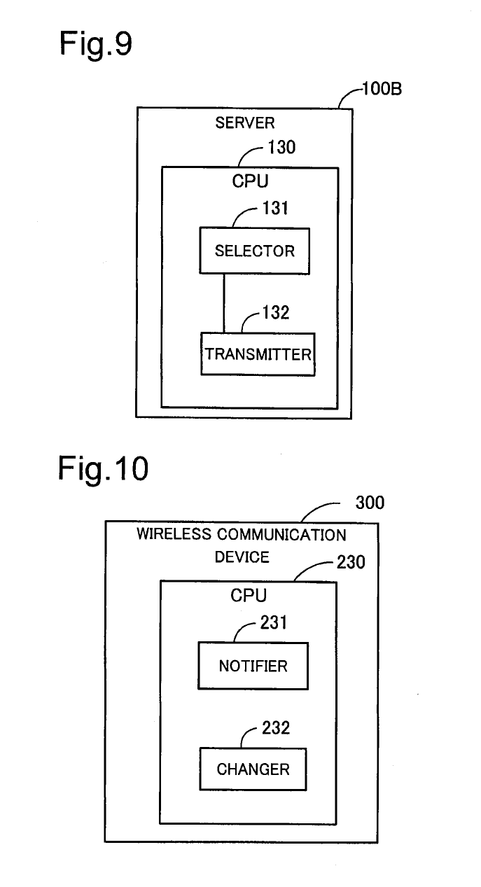

The following describes the second embodiment with reference to the drawings. FIG. 9 illustrates the internal configuration of the server 100B according to the second embodiment. The server 100B includes a CPU 130. The CPU 130 performs a channel mapping process of the second embodiment to serve as the selector 131 and the transmitter 132.

FIG. 10 illustrates the internal configuration of the wireless communication device 300 according to the second embodiment. The wireless communication device 300 includes a CPU 230. The CPU 230 performs a channel control process of the second embodiment to serve as the notifier 231 and the changer 232. The system configuration is identical with that of the first embodiment (FIG. 1).

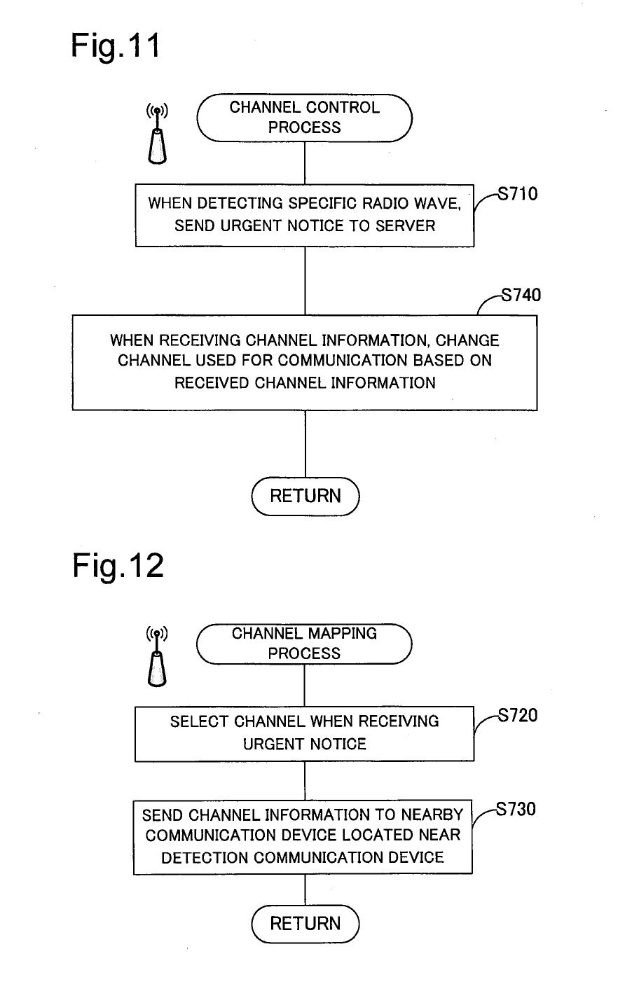

FIG. 11 is a flowchart showing the channel control process according to the second embodiment. The channel control process is performed by the CPU 230 of the wireless communication device 300. When detecting specific radio wave, the notifier 231 sends an urgent notice to the server 100B (step S710).

When receiving channel information, on the other hand, the changer 232 changes the channel used for communication, based on the received channel information (step S740).

FIG. 12 is a flowchart showing the channel mapping process according to the second embodiment. When receiving the urgent notice, the selector 131 selects a channel (step S720). Subsequently the transmitter 132 sends channel information to a nearby communication device located near the detection communication device (wireless communication device 300 which has sent the urgent notice) (step S730).

The second embodiment enables the position information of the wireless communication device 300 to be specifically used for determination of the channel after change. When a certain wireless communication device 300 detects specific radio wave, there is a possibility that another wireless communication device 300 (nearby communication device) which is located near the certain wireless communication device 300 (detection communication device) and uses at least part of the channels used by the detection communication device also detects specific radio wave in a while. Accordingly, the nearby communication device changes the channel based on the channel information received from the server, so that the possibility that the nearby communication device detects specific radio wave is reduced.

### C. Modifications

The disclosure is not limited to the above embodiments, examples or modifications, but a diversity of variations and modifications may be made to the embodiments without departing from the scope of the disclosure. For example, the technical features of the embodiments, examples or modifications corresponding to the technical features of the respective aspects described in SUMMARY may be replaced or combined appropriately, in order to solve part or all of the problems described above or in order to achieve part or all of the advantageous effects described above. Any of the technical features may be omitted appropriately unless the technical feature is described as essential herein. Some of possible modifications are given below.

The following modifications are available with regard to performing or not performing CAC and selecting a recommended channel:

(1) The wireless communication device which sends an urgent notice (detection communication device) may perform CAC at the channel specified by the recommended channel information at step S370 in FIG. 5. This CAC may be ended in a shorter time than the predetermined time (for example, 1 minute);

(2) The wireless communication device which receives the recommended channel information (nearby communication device) may not perform CAC at step S640 in FIG. 8;

(3) The server may determine whether CAC is to be performed based on the table and add a result of this determination to the recommended channel information which is sent in response to the urgent notice at step S440 in FIG. 7;

(4) The wireless communication device may request the server to provide recommended channel information in response to the user's instruction; and

(5) When receiving recommended channel information in response to the urgent notice, the channel change process of FIG. 8 may change the channel independently of the recommended channel information.

In the embodiment described above, the “nearby communication device” is defined as a device having the similar geographical conditions to those of a wireless communication device of interest (e.g., regular notification device). In addition to these conditions or in place of these conditions, the “nearby communication device” may be defined as a wireless communication device in the coverage of radar wave estimated by the server.

The following modifications are available with regard to the configuration and the functions of the server:

(1) The server may select a channel by additionally considering information regarding a radar device at step S440 in FIG. 7. The radar device may be, for example, a stationary radar such as weather radar or a moving radar incorporated in transportation equipment such as passenger aircraft and ships and boats. In some cases, the frequency of radar wave emitted from such a radar device, the date and time of emission, the position of emission, the angle of emission and the like may be opened to the public. The server may obtain the opened information by, for example, the Internet and select a channel to avoid radar wave from the radar device;

(2) When predicting emission of radar wave from transportation equipment as the result of learning, the server may send recommended channel information to each wireless communication device located in the coverage of radar wave from the transportation equipment. The channel specified by the recommended channel information may be a channel to avoid the predicted radar wave. An available method of the above prediction may use an urgent notice from a wireless communication device located near the transportation equipment;

(3) The server may collect detection information of radar wave from radar wave detectors incorporated in transportation equipment (e.g., public transportation system and private automobiles) and radar wave detectors incorporated in communication devices for mobile communication (e.g., smartphones). The radar wave detector may be a wireless communication device or a dedicated machine for radar wave detection. Since the transportation equipment and the communication devices for mobile communication move, this technique can collect data in a wide area; and

(4) The server may be connected to the Internet by wireless.

The following modifications are available with regard to the configuration and the functions of the wireless communication device:

(1) When the wireless communication device is a stationary type (e.g., broadband router), the wireless communication device may obtain the own current position from the user's entry or may obtain the current position by using Wi-Fi (registered trademark). In such applications, the GPS receiver 260 (FIG. 3) may be omitted;

(2) The wireless communication device may establish direct communication with the server like the embodiment or may establish communication with the server via another wireless communication device;

(3) The radio wave as the target of detection may be other than radar wave, for example, radio wave emitted from medical equipment; and

(4) The wireless communication standard employed by the wireless communication device may be a different standard other than the IEEE 802.11 standard. It is, however, preferable to employ a wireless communication standard having the similar characteristics to those of the IEEE 802.11 standard in terms of the need of verification that no specific radio wave has been detected for a predetermined time at one or more channels selected among a plurality of channels before starting wireless communication using the selected channel.

The disclosure may be additionally provided as the following aspects:

### <Aspect 1>

There is provided a system, comprising: a plurality of wireless communication devices each configured to transmit a notification that reception of a specific radio wave has been detected; and a server configured to communicate with the plurality of wireless communication devices, the server comprising circuitry configured to select a channel recommended to be used upon receiving the notification from a first wireless communication device of the plurality of wireless communication devices; and transmit channel information indicating the recommended channel to a second wireless communication device of the plurality of wireless communication devices that is located near the first wireless communication device, wherein the second wireless communication device is configured to change a channel used for communication based on the received channel information. In this communication system, the wireless communication device comprises a notifier that, when detecting the specific radio wave, sends a notice of detection result to the server; the server comprises a selector that, when receiving the notice, selects a channel after change based on the received notice, and a transmitter that sends channel information indicating the channel selected by the selector to another wireless communication device located near the wireless communication device which is a sender of the notice; and the wireless communication device further comprises a changer that, when receiving the channel information, changes a channel used for communication based on the received channel information. This aspect enables the position information of a wireless communication device to be specifically used for determination of the channel after change. When a certain wireless communication device detects specific radio wave, there is a possibility that another wireless communication device (hereinafter referred to as nearby communication device) which is located near the certain wireless communication device (hereinafter referred to as detection communication device) and uses at least part of the channels used by the detection communication device also detects specific radio wave in a while. According to this aspect, the nearby communication device changes the channel based on the channel information received from the server, so that the possibility that the nearby communication device detects specific radio wave is reduced.

### <Aspect 2>

The circuitry is configured to send, to the first wireless communication device, channel information indicating a channel recommended to be used by the first wireless communication device based on records of notifications received from the plurality of wireless communication devices upon receiving the notification. According to this aspect, the detection communication device uses the channel selected based on the records of the notices and can thus readily avoid a channel which is likely to detect the specific radio wave again.

### <Aspect 3>

The second wireless communication device is configured to change to a channel specified by the received channel information without verifying that a specific radio wave has been detected at the channel for a predetermined time. This aspect shortens the communication interruption time accompanied with a change of the channel. The above term “without verifying” includes “verifying that no specific radio wave has been detected at the selected channel for a shorter time than the predetermined time.”

### <Aspect 4>

The circuitry is configured to select the recommended channel after the change based on information obtained from other than the notification. This aspect increases the probability of selection of a channel which is unlikely to detect the specific radio wave.

### <Aspect 5>

The information obtained from other than the notification includes information regarding a weather condition.

### <Aspect 6>

The circuitry is configured to select the recommended channel based on a location of the second wireless communication device. This aspect enables a channel to be selected by additionally considering the place where the wireless communication device is located.

### <Aspect 7>

The circuitry is configured to: estimate that an object emitting the specific radio wave is to move; and transmit channel information to one of the plurality of wireless communication devices which is expected to detect the specific radio wave within a predetermined time corresponding to the estimated movement of the object. This aspect urges another wireless communication device located in the coverage of a moving radar to change a channel before detection of radar wave.

### <Aspect 8>

The circuitry is configured to identify one of the plurality of wireless communication devices as the second communication device based on a proximity of the second wireless communication device to the first wireless communication device.

### <Aspect 9>

The system according to claim 1, wherein the circuitry is configured to identify one of the plurality of wireless communication devices as the second communication device based on a difference of a parameter value in a predetermined range from a parameter value of the first wireless communication device with respect to a specific radar wave detection parameter.

### <Aspect 10>

The system according to claim 1, wherein the plurality of wireless communication devices are each configured to communicate wirelessly according to a standard that requires verification that the specific radio wave has not been detected for a predetermined period of time in a channel before selecting the channel for communicating.

### <Aspect 11>

The system according to claim 10, wherein the specific radio wave is a radar wave detected in a 5.25 to 5.35 GHz and a radar wave detected in a 5.470 to 5.570 GHz channel.

The plurality of structural components included in each aspect of the disclosure described above are not all essential, but some structural components among the plurality of structural components may be appropriately changed, omitted or replaced with other structural components or part of the limitations may be deleted, in order to solve part or all of the problems described above or in order to achieve part or all of the advantageous effects described herein. In order to solve part or all of the problems described above or in order to achieve part or all of the advantageous effects described herein, part or all of the technical features included in one aspect of the disclosure described above may be combined with part or all of the technical features included in another aspect of the disclosure described above to provide still another independent aspect of the disclosure.

For example, one aspect of the disclosure may be implemented as a system including part of all of the two components: a device and a server. This system may include or may not include devices. This system may include or may not include a server. The devices may be, for example, each configured to transmit a notification that reception of a specific radio wave has been detected. The server may be configured to: for example, select a channel recommended to be used upon receiving the notification from a first wireless communication device of the plurality of wireless communication devices. The server may be configured to: for example transmit channel information indicating the recommended channel to a second wireless communication device of the plurality of wireless communication devices that is located near the first wireless communication device, wherein the second wireless communication device is configured to change a channel used for communication based on the received channel information. This system may be implemented, for example, as a communication system but may also be implemented as a different system other than the communication system. This aspect can solve at least one of various problems, for example, downsizing of the device, cost reduction, resource saving, easiness of manufacture and improved usability. Part of all of the technical features involved in the respective embodiments of the communication system described above may also be applicable to this system.

The disclosure may be implemented by various aspects other than those described above: for example, a communication method, a program for implementing this method, a non-transitory storage medium in which this program is stored, a wireless communication device alone or a server alone.

1. A system, comprising:
a plurality of wireless communication devices each configured to transmit a notification that reception of a specific radio wave has been detected; and
a server configured to communicate with the plurality of wireless communication devices, the server comprising
circuitry configured to
select a channel recommended to be used upon receiving the notification from a first wireless communication device of the plurality of wireless communication devices; and
transmit channel information indicating the recommended channel to a second wireless communication device of the plurality of wireless communication devices that is located near the first wireless communication device, wherein
the second wireless communication device is configured to change a channel used for communication based on the received channel information.

2. The system according to claim 1, wherein
the circuitry is configured to send, to the first wireless communication device, channel information indicating a channel recommended to be used by the first wireless communication device based on records of notifications received from the plurality of wireless communication devices upon receiving the notification.

3. The system according to claim 2, wherein
the second wireless communication device is configured to change to a channel specified by the received channel information without verifying that a specific radio wave has been detected at the channel for a predetermined time.

4. The system according to claim 1, wherein
the circuitry is configured to select the recommended channel after the change based on information obtained from other than the notification.

5. The system according to claim 4, wherein
the information obtained from other than the notification includes information regarding a weather condition.

6. The system according to claim 1, wherein
the circuitry is configured to select the recommended channel based on a location of the second wireless communication device.

7. The system according to claim 1, wherein the circuitry is configured to:
estimate that an object emitting the specific radio wave is to move; and
transmit channel information to one of the plurality of wireless communication devices which is expected to detect the specific radio wave within a predetermined time corresponding to the estimated movement of the object.

8. The system according to claim 1, wherein
the circuitry is configured to identify one of the plurality of wireless communication devices as the second communication device based on a proximity of the second wireless communication device to the first wireless communication device.

9. The system according to claim 1, wherein
the circuitry is configured to identify one of the plurality of wireless communication devices as the second communication device based on a difference of a parameter value in a predetermined range from a parameter value of the first wireless communication device with respect to a specific radar wave detection parameter.

10. The system according to claim 1, wherein
the plurality of wireless communication devices are each configured to communicate wirelessly according to a standard that requires verification that the specific radio wave has not been detected for a predetermined period of time in a channel before selecting the channel for communicating.

11. The system according to claim 10, wherein
the specific radio wave is a radar wave detected in a 5.25 to 5.35 GHz and a radar wave detected in a 5.470 to 5.570 GHz channel.

12. An information processing apparatus comprising:
circuitry configured to
select a channel recommended to be used upon receiving a notification of a detection result indicating that a first wireless communication device among a plurality of wireless communication devices has detected a specific radio wave; and
transmit channel information indicating the recommended channel a second wireless communication device among the plurality of wireless communication devices located near the first wireless communication device.

13. The information processing apparatus according to claim 12, wherein
the circuitry is configured to send, to the first wireless communication device, channel information indicating a channel recommended to be used by the first wireless communication device based on records of notifications received from the plurality of wireless communication devices upon receiving the notification.

14. The information processing apparatus according to claim 12, wherein
the circuitry is configured to select the recommended channel after the change based on information obtained from other than the notification.

15. The information processing apparatus according to claim 14, wherein
the information obtained from other than the notification includes information regarding a weather condition.

16. The information processing apparatus according to claim 12, wherein
the circuitry is configured to select the recommended channel based on a location of the second wireless communication device.

17. The information processing apparatus according to claim 12, wherein the circuitry is configured to:
estimate that an object emitting the specific radio wave is to move; and
transmit channel information to one of the plurality of wireless communication devices which is expected to detect the specific radio wave within a predetermined time corresponding to the estimated movement of the object.

18. The information processing apparatus according to claim 12, wherein
the circuitry is configured to identify one of the plurality of wireless communication devices as the second communication device based on a proximity of the second wireless communication device to the first wireless communication device or based on a difference of a parameter value in a predetermined range from a parameter value of the first wireless communication device with respect to a specific radar wave detection parameter.

19. A non-transitory computer-readable medium including computer program instructions, which when executed by an information processing apparatus, cause the information processing apparatus to:
select a channel recommended to be used upon receiving a notification of a detection result indicating that a first wireless communication device among a plurality of wireless communication devices has detected a specific radio wave; and
transmit channel information indicating the recommended channel a second wireless communication device among the plurality of wireless communication devices located near the first wireless communication device.
